(19) United States
(12) Patent Application Publication
(10) Pub. No.: US 2017/0213215 A1
(43) Pub. Date: Jul. 27, 2017

(54) Systems and Methods for Coordinating Commerce Associated With Premises

(71) Applicant: MASTERCARD INTERNATIONAL INCORPORATED, Purchase, NY (US)

(72) Inventors: Charles Sangwon Lee, Briarcliff Manor, NY (US); Michael Jason Friedman, Stamford, CT (US); Sherri Gayle Haymond, Darien, CT (US)

(21) Appl. No.: 15/417,164

(22) Filed: Jan. 26, 2017

Related U.S. Application Data
(60) Provisional application No. 62/287,629, filed on Jan. 27, 2016.

(51) Int. Cl. G06Q 20/40; G06Q 20/22

(52) U.S. Cl. CPC G06Q 20/401; G06Q 20/22

(57) ABSTRACT

Disclosed are exemplary embodiments of systems and methods for coordinating commerce associated with a premises. One exemplary method includes detecting a condition of a premises via a device at the premises; determining whether a product purchase is indicated based on the detected condition; and when a product purchase is indicated, initiating, by a commerce engine at the premises, a purchase transaction for a product associated with the product purchase determination, using a payment credential associated with a payment account and included in the commerce engine.

### CROSS-REFERENCE TO RELATED APPLICATION

This application claims the benefit of, and priority to, U.S. Provisional Application No. 62/287,629, filed Jan. 27, 2016. The entire disclosure of the above application is incorporated herein by reference.

### FIELD

The present disclosure generally relates to systems and methods for coordinating commerce, associated with premises, to payment accounts, based on data associated with devices at the premises.

### BACKGROUND

This section provides background information related to the present disclosure which is not necessarily prior art.

People are known to dwell, entertain, visit, and/or work in homes, buildings, complexes, and/or other structures (broadly, premises). The premises rely on different devices to provide various features and/or functions at the premises, such as, for example, lighting, heating, cooling, food storage/service, laundry, entertainment, etc. In addition, the devices that provide such features and/or functions around the premises have become automated, whereby a person's participation in a feature and/or function of a device may be limited, or wholly omitted. Separately, products (e.g., goods, services, etc.) are known to be purchased from merchants, through use of payment accounts and/or other funding means. Often, the purchased products are used in conjunction with the devices at the premises to accomplish the various features and/or functions of the devices (e.g., filters may be purchased for use in furnaces, etc.).

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for coordinating commerce to a payment account based on one or more device located at a premises;

FIG. 2 is a block diagram of a computing device that may be used in the exemplary system of FIG. 1; and

FIG. 3 is an exemplary method, which may be implemented in the system of FIG. 1, for example, for coordinating commerce to the payment account based on the one or more device located at the premises.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Premises such as homes, buildings, complexes, and/or other structures and/or land often rely on different devices to provide various features and/or functions at the premises (e.g., lighting, heating, cooling, food storage/service, laundry, entertainment, etc.). Various ones of the devices may be automated and/or intelligent, whereby the devices function at least partially independent of inputs from people within the premises. Uniquely, the systems and methods herein leverage one or more of the devices at the premises to coordinate commerce associated with the premises. In particular, a commerce engine is provided with a payment credential associated with at least one payment account, and also connected with one or multiple of the devices at the premises (or at multiple premises). As data from the devices indicates commerce is needed, the commerce engine coordinates purchase transactions for products (e.g., goods, services, etc.). As such, a person at the premises is able to rely on the commerce engine to make, or at least suggest, purchase transactions, for example, for the benefit of the premises. Further, the commerce engine may play a role in coordinating with other commerce engines, acting on a profile associated with a person at the premises, causing payments in response to detected people at the premises, providing loyalty rewards and/or incentives to people at the premises, and/or facilitating pay-per use products at the premises, etc.

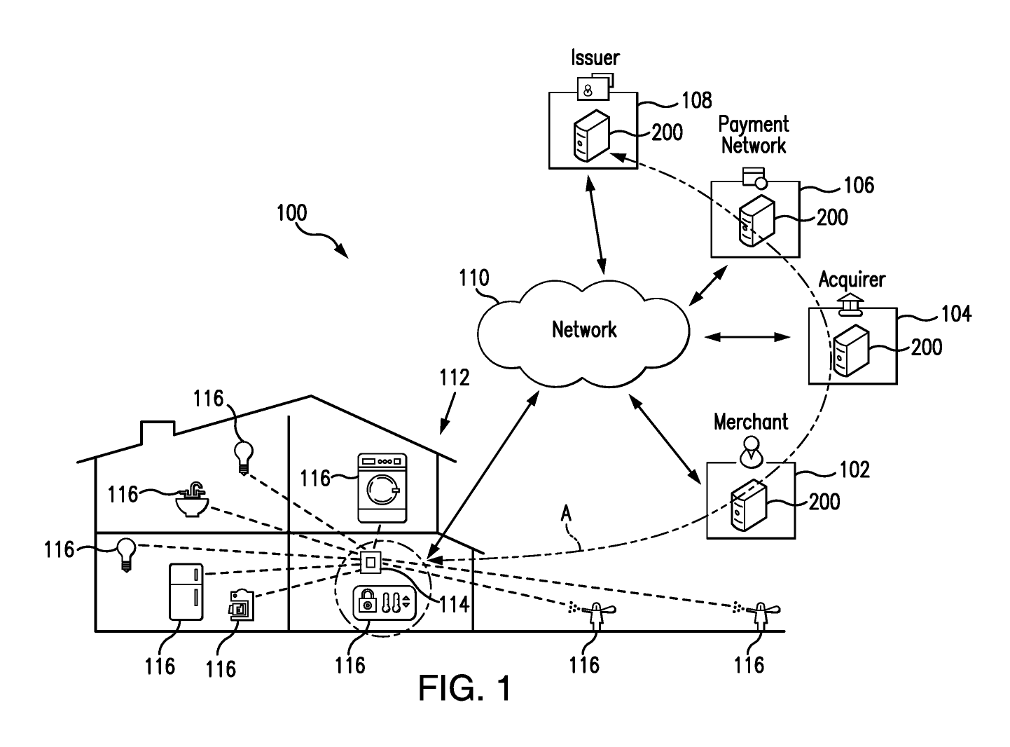

FIG. 1 illustrates an exemplary system 100, in which one or more aspects of the present disclosure may be implemented. Although, in the described embodiment, the system 100 is presented in one arrangement, other embodiments may include the system 100 arranged otherwise, depending, for example, on processing of purchase transactions, connectivity associated with premises, etc.

The illustrated system 100 generally includes, in connection with facilitating purchase transactions, a merchant 102, an acquirer 104, a payment network 106, and an issuer 108, each coupled to (and in communication with) network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In this example, the network 110 may include a private payment transaction network made accessible by the payment network 106 to the acquirer 104 and the issuer 108 and, separately, a public network such as the Internet through which the merchant 102 and/or a commerce engine, for example, may communicate.

The system 100 also includes a premises 112, and a commerce engine 114 associated with the premises 112. The commerce engine 114 is coupled to (or in communication with) the network 110. The premises 112 includes a residential home, for example. It should be appreciated, however, that the premises 112 may include, without limitation, any building, dwelling, home, construction, complex, farm, location, or other structure and/or land, which may be public, private, commercial and/or residential, etc., where people tend to live, entertain, work, etc. Further, while not required (or shown), multiple premises and/or commerce engines may be included in other system embodiments. In one example, the premises 112 is one of multiple neighboring and/or adjacent premises, where each of the premises includes a commerce engine.

As shown in FIG. 1, the premises 112 includes a variety of different devices 116. The devices 116 may include any device that is associated with the premises 112, and employed to accomplish one or more operations associated with the premises 112. Specifically, for example, a light fixture (e.g., a light bulb, etc.) may be employed to provide lighting for one or more rooms at the premises 112. A washing machine may provide laundry operations, while a bathtub may provide bathing operations. And, a refrigerator may provide food storage operations. Likewise, a coffee maker may provide coffee brewing operations. Further, a HVAC system may provide heating, ventilation, and cooling operations to the interior of a residential home of the premises 112, while a security system (including motion sensors, cameras, etc.) may provide for alarm operations related to fire, medical emergencies and/or security breaches, etc. The devices 116 also extend beyond the residential home of the premises 112 to the surrounding land, and include, for example, sprinklers that provide irrigation operations to grass, landscaping, etc. Various other devices may further be situated about the premises 112 to provide additional and/or other operations associated with the premises 112. Such other devices may include, without limitation, kitchen appliances, entertainment units (e.g., televisions, game consoles, DVD players, etc.), telecommunication units, computing devices, ingress/egress systems (e.g., door locks, access panels, etc.), recreational equipment, maintenance equipment, climate control equipment (e.g., thermostat, etc.), smoke detectors, garage doors/garage door openers, etc. In various embodiments, operations performed by the devices 116 may include providing states of and/or feedback (broadly, conditions) from other devices (e.g., a sensor providing feedback from a HVAC system, etc.).

Each of the devices 116 at the premises 112 is coupled to at least the commerce engine 114 associated with the premises 112, via one or more networks, as indicated by the dotted lines in FIG. 1. The one or more networks may be part of the network 110, or may be separate therefrom (and associated with the premises 112, or not). In addition, the number and/or types of the one or more networks may be dependent, for example, on the types and/or number of devices 116 included at the premises 112. For example, a light bulb may include a ZigBee compatible device, while a washing machine may include a Z-wave compatible device. In any case, the commerce engine 114 is compatible with at least one network, or with multiple networks, to communicate with each of the different devices 116. With that said, it should be appreciated that the devices 116 may be compatible with, for example, Bluetooth, ZigBee, Z-Wave, Thread, Nest Weave, or other protocols, etc., and/or also, LoRa, RPMA, or other machine network protocols, etc. The device connections to the commerce engine 114 may be wired or wireless. In at least one embodiment, a first device 116 is coupled to (and is in communication with) an intermediate device (e.g., a hub associated with multiple of the devices 116, etc.), which is compatible with the first device 116, and where the intermediate device is then coupled to (and communicates with) the commerce engine 114 (e.g., to report a condition from the first device 116 to the commerce engine 114, etc.). In another embodiment, a first device 116 is coupled to (and is in communication with) a second device 116 (e.g., a network of connected devices, etc.), and where the second device 116 is then coupled to (and in communication with) the commerce engine 114 (e.g., to report conditions from both the first device 116, the second device 116, and/or other devices coupled thereto, etc.). In general in the system 100, the commerce engine 114 is configured to look for permitted ones of the devices 116 (e.g., certified or registered ones of the devices 116, compliant ones of the devices 116, whitelisted ones of the devices 116, etc.), and then pair with such permitted ones of the devices 116. Such devices may be identified to the commerce engine 114 by the consumer associated with the premises, or such devices may be predefined (e.g., as manufactured, etc.) as permitted to pair with the commerce engine 114. In this manner, the commerce engine 114 is configured to disregard, or ignore (and not connect with), devices that are not permitted to (or registered to or paired with) the commerce engine 114. In other embodiments, however, the commerce engine 114 may be configured to connect with all available devices, when such connection is available and/or when the devices are configured for such connection.

In the illustrated system 100, the commerce engine 114 is a standalone device included at the premises 112 (e.g., in the residential home at the premises 112, etc.). In other embodiments, however, the commerce engine 114 may be integrated in and/or incorporated with one or more of the devices 116. Specifically, for example, and as illustrated by the dotted circle in FIG. 1, the commerce engine 114 may be integrated with a home security and/or home thermostat at the premises 112. In such embodiments, the commerce engine 114 may include an application, i.e., an internet-based application, which is loaded to the device 116 and executed thereby. The application may include the commerce engine 114, or a part of the commerce engine 114. In at least one example, an application segment is installed in a home device, which operates as the commerce engine 114 described herein through one or more application programming interface (API) calls to the payment network 106 or other entity within the system 100, or otherwise, to facilitate desired purchase transactions (as will be described in more detail hereinafter).

Further in the system 100, a payment account is associated with one or more of the premises 112, the commerce engine 114, and/or a person/entity associated with the premises 112, for use in making purchases for products related to the premises 112. The payment account may be issued, by the issuer 108, to the person/entity (broadly, a consumer) associated with the premises 112 (not shown), such as, for example, an owner, a tenant, a building manager, a business employee, a guest, etc., or a business associated with the premises 112, etc. The payment account may be issued directly to the consumer, or the consumer may merely have access to the payment account, for example, to make purchases related to the premises 112. While the payment account may be linked to any known payment device (e.g., credit card, e-wallet application, etc.), the payment account, in this exemplary embodiment, is further linked to the commerce engine 114.

In particular, for example, the commerce engine 114 may be configured to pair with a digital wallet service at the payment network 106 (e.g., Masterpass by MasterCard®, etc.) and with a tokenization service (e.g., the MasterCard Digital Enablement Express (MDES) service by MasterCard®, etc.) to acquire and store tokenized credentials associated with the consumer's payment account. In turn, tokenized credentials representing the payment account (broadly, a payment account credential) may be stored in the commerce engine 114 using a secure element (or stored at the payment network 106 (e.g., in memory of a computing device associated with the payment network, etc.) using host card emulation, etc.), whereby the commerce engine 114 is able to initiate or cause transactions to the consumer's payment account, including purchase transactions and payment transactions. As indicated, the token may be stored in the commerce engine 114 (or in a data structure associated with the commerce engine 114) or at the payment network 106 (or in a data structure associated therewith) and may be static and/or dynamic, whereby the token is reissued at one or more regular or irregular intervals, while remaining associated with the payment account. It should be appreciated that while the commerce engine 114 is described as linked with the token, in other embodiments, multiple tokens may be linked with the commerce engine 114 and/or the devices 116 for various reasons, including, for example, to attribute purchases per device, per group of devices, per operation, per brand, per consumer, per protocol, etc.

In this exemplary embodiment, the commerce engine 114 is configured to detect at least one condition of the premises 112 and determine whether a purchase transaction is indicated (e.g., should be initiated, etc.), based on the detected condition. The commerce engine 114 is further configured to, when a purchase transaction is indicated, initiate the purchase transaction and, in particular, transmit a payment credential (broadly, a purchase request) to the merchant 102. The purchase request includes the token linked to the commerce engine 114 (and associated with the consumer's payment account). The merchant 102, in turn, receives the purchase request and causes an authorization request to be generated and/or transmitted to the acquirer 104. In turn, the acquirer 104 communicates the authorization request (including the commerce engine's token) to the issuer 108, through the payment network 106 (which replaces the token with a payment account number (PAN) for the consumer's payment account), such as, for example, through MasterCard®, VISA®, Discover®, American Express®, etc. In turn, if approved, an authorization reply (indicating the approval of the transaction) is transmitted back from the issuer 108, through the payment network 106 (which retokenizes the PAN for the consumer's payment account), and to the merchant 102, along path A, thereby permitting the merchant 102 to complete the transaction. The transaction is later cleared and/or settled by and between the merchant 102, the acquirer 104, and the issuer 108. If declined, however, the authorization reply (indicating a decline of the transaction) is provided back to the merchant 102, along path A, thereby permitting the merchant 102 to halt or terminate the transaction.

Transaction data is generated, collected, and stored as part of the above interactions among the merchant 102, the acquirer 104, the payment network 106, the issuer 108, and the commerce engine 114. The transaction data represents at least a plurality of transactions, for example, authorized transactions, cleared transactions, attempted transactions, etc. The transaction data, in this exemplary embodiment, is stored at least by the payment network 106 (e.g., in a data structure associated with the payment network 106, etc.). Additionally, or alternatively, the merchant 102, the acquirer 104 and/or the issuer 108 may store the transaction data, or part thereof, in a data structure, or transaction data may be transmitted between parts of system 100, as used or needed (e.g., for clearing, etc.). The transaction data may include, for example, payment account numbers (e.g., primary account numbers (PANs), etc.), amounts of the transactions, tokens (and/or token IDs), merchant IDs, merchant category codes (MCCs), dates/times of the transactions, products purchased and related descriptions or identifiers, etc. It should be appreciated that more or less information related to transactions, as part of either authorization, clearing, and/or settling, may be included in transaction data and stored within the system 100, at the merchant 102, the acquirer 104, the payment network 106, and/or the issuer 108.

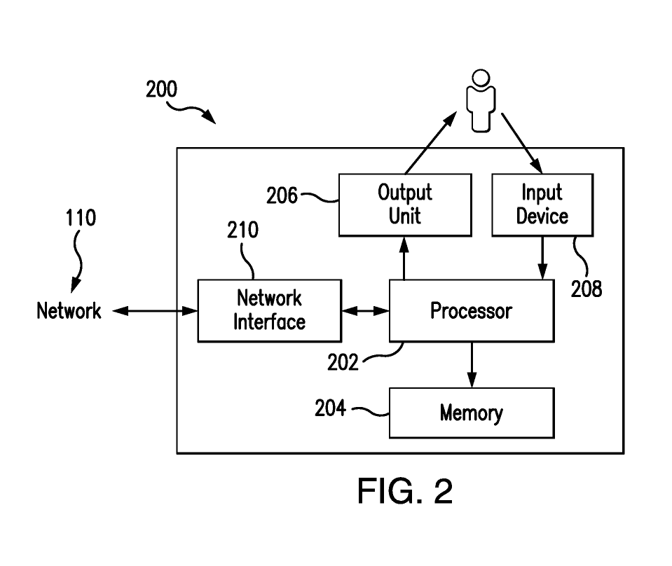

FIG. 2 illustrates an exemplary computing device 200 that can be used in the system 100 of FIG. 1. The computing device 200 may include, for example, one or more servers, workstations, computers, on-board vehicle computers, tablets, laptops, smartphones, PDAs, fobs, fitness tracking wristbands, POS terminals, vehicles, etc. In addition, the computing device 200 may include a single computing device, or it may include multiple computing devices located in close proximity or distributed over a geographic region, so long as the computing devices are specifically configured to function as described herein. However, the system 100 should not be considered to be limited to the computing device 200, as described below, as different computing devices and/or arrangements of computing devices may be used

In the exemplary embodiment of FIG. 1, each of the merchant 102, the acquirer 104, the payment network 106, and the issuer 108 are shown as including, or being implemented in, a computing device 200, coupled to (and in communication with) the network 110. In addition in the exemplary embodiment of FIG. 1, the commerce engine 114 is consistent with computing device 200, and each of the various devices 116 may be considered computing devices consistent, at least in part, with computing device 200.

The exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, payment account information (e.g., tokens, token IDs, PANs, or other payment credentials, etc.), consumer information (e.g., names, addresses, content information, vehicle identifiers, vehicle access credentials, etc.), device information (e.g., device type, device brand, etc.), merchant information (e.g., merchant names, merchant IDs, product prices, merchant/product locations, etc.), and/or other types of data suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein. It should be appreciated that the memory 204 may include a variety of different memories, each implemented in one or more of the functions or processes described herein.

In the exemplary embodiment, the computing device 200 includes an output unit (or device) 206 that is coupled to (and in communication with) the processor 202. The output unit 206 outputs information, either visually or audibly, to a user of the computing device 200, such as, for example, a consumer in the system 100 or other person interacting with one of the devices 116, for example. It should be further appreciated that various interfaces (e.g., as defined by internet-based applications, etc.) may be displayed at computing device 200, and in particular at output unit 206, to display such information. The output unit 206 may include, without limitation, a liquid crystal display (LCD), a light-emitting diode (LED) display, an LED, an organic LED (OLED) display, an “electronic ink” display, speakers, or any other device suitable to output information to the user, etc.

The computing device 200 also includes an input device 208 that receives inputs from the user (i.e., user inputs) such as, for example, inputs to define a purchase rule, etc. The input device 208 is coupled to (and in communication with) the processor 202 and may include, for example, a keyboard, a pointing device, a mouse, a button, a stylus, a touch sensitive panel (e.g., a touch pad or a touch screen, etc.), another computing device, and/or an audio input device. Further, in various exemplary embodiments, a touch screen, such as that included in a tablet, a smartphone, a vehicle dash, or similar device, behaves as both a presentation unit and an input device. In at least one embodiment, the computing device omits the output unit 206 and/or the input device 208.

In addition, the illustrated computing device 200 also includes a network interface 210 coupled to (and in communication with) the processor 202 and the memory 204. The network interface 210 may include, without limitation, a wired network adapter, a wireless network adapter (e.g., an NFC adapter, a Bluetooth adapter, a WI-FI adapter, a ZigBee adapter, etc.), a mobile network adapter, or other device capable of communicating to/with one or more different networks, including the network 110. In one example, the network interface 210 includes a RFID interface, etc. Further, in some exemplary embodiments, the computing device 200 includes the processor 202 and one or more network interfaces 210 incorporated into or with the processor 202.

With reference again to FIG. 1, in general in the system 100, when active, the commerce engine 114 is configured to recognize the various devices 116 at the premises 112. For example, upon initially installing a device 116 at the premises 112 (e.g., upon activating or powering the device 116, etc.), the device 116 is configured to discover the commerce engine 114. In connection therewith, the device 116 may be identified as a certificate device (or a whitelisted device) to the commerce engine 114 (e.g., as predefined to the device 116 prior to installation, as identified by the consumer installing the device 116, etc.), whereby the device 116 is configured to then connect to the commerce engine 114 (and the commerce engine 114 is configured to allow such connection), as described above, and to send its name and/or device ID to the commerce engine 114. The commerce engine 114 is configured to then store the received data for the device 116 in memory (e.g., in memory 204, etc.).

Then, in connection with the devices 116, and as described above, the commerce engine 114 is specifically configured to detect one or more conditions at the premises 112 (via the devices 116) and, based on one or more purchase rules, initiate a purchase transaction with one or more merchants. In general, the purchase rules are defined by the consumer to indicate, to the commerce engine 114, when a purchase transaction is to be initiated, and may be related to a variety of conditions of the devices 116 at the premises 112. However, in various embodiments, the purchase rules may be predefined at the commerce engine 114 and/or at one or more of the devices 116 (e.g., upon receipt/installation of the commerce engine 114 and/or the one or more devices 116 by the consumer, etc.).

It should be appreciated that the commerce engine 114 may operate in accordance with any number of purchase rules implemented by and/or received from one or more of the connected devices 116, to cause a purchase transaction. Table 1 includes various exemplary purchase rules that may be implemented by various ones of the devices 116 for different products. And, when the devices 116 determine that such rules are satisfied, purchase instructions are communicated by the devices 116 to the commerce engine 114 to initiate purchases for the associated products.

TABLE 1

| Product | Rule |
|---|---|
| Laundry/ | Purchase after X cycles, where X is an integer |
| Dishwasher | |
| Detergent | |
| Oil | Purchase X gallons when oil tank level drops below a |
| | threshold amount, percentage, or level; or Purchase X |
| | gallons when oil price falls below a defined threshold |
| Lawn Fertilizer | Purchase lawn fertilizer treatment when soil reading |
| | deviates from predefined phosphorus, nitrogen, and |
| | potassium composition |
| Air Filter | Purchase air filter when air quality falls below |
| | predefined threshold, or after X months of use |
| | following prior replacement, where X is an integer |
| Wood | Purchase wood for fireplace after X uses, where X is an |
| | integer |
| Chimney | Purchase chimney cleaning service after Y uses of |
| Cleaning | fireplace, where Y is an integer |
| Pool Chemicals | Purchase pool chemicals when concentration deviates |
| | from predefined threshold |
| Propane | Purchase propane for grill after X uses, where X is an |
| | integer |
| Salt | Purchase salt for a water softener after X cycles, where |
| | X is an integer |
| Light bulb | Purchase light bulb when currently installed lightbulb |
| | goes out |
| Septic Cleaning | Schedule Septic Cleaning after X flushes or Y gallons |
| | or Z time passes, where X, Y, and Z are integers |

In so doing, the purchase rules implemented by the various devices 116 may further include indications of desired products to purchase and/or particular merchants from which to purchase the desired products (as predefined to the devices 116, as specified by the consumer associated with the devices 116, etc.). Or, such determinations may be made by the commerce engine 114, for example, based on prior purchases relating to the same or similar devices 116, for the same or similar products, or based on predefined instructions or on prior instructions from the consumer.

In order for the consumer to define the purchase rules, for example, a management interface is provided in (or associated with) the system 100, in this exemplary embodiment. The management interface may be provided via a website and/or internet-based application, which may be hosted and/or managed at the commerce engine 114 or another device associated with a service provider (not shown). In use, the consumer is able to set up purchase rules through the management interface. The consumer may access the management interface via computing device 200 (e.g., smartphone, laptop, tablet, etc.), and log-on using appropriate credentials (e.g., username, password, passcode, etc.). Once logged-on, the consumer then defines the particular purchase rule(s) to be created for the devices 116. For example, the consumer may provide an identification of a device (e.g., a washing machine, etc.), a threshold condition associated with the device (e.g., sixteen wash cycles, etc.), a merchant, a type of product to be purchased when the threshold condition is satisfied (e.g., 36 oz. BRAND X detergent, etc.), and any additional limitations, parameters, authentications or other criteria for the purchase rule. Once the purchase rule is created, it is stored at the device (e.g., in memory 204, etc.), or in some embodiments potentially in the commerce engine 114 (and/or associated memory 204), and retrieved as necessary by the given device to evaluate and determine whether, or not, the commerce engine 114 should cause a purchase transaction consistent with the given purchase rule. After its creation, the management interface permits the consumer to delete and/or modify the rule, or even to put a hold on the purchase rule, for one or more reasons.

More generally in this embodiment, the management interface is provided to permit the consumer to monitor and/or govern (and authorize or approve as appropriate) transactions initiated by the commerce engine 114 (broadly, is configured to facilitate various services available to the consumer). Specifically, for example, the consumer is able to add and/or delete tokenized payment credentials, turn on/off payment capabilities of the commerce engine 114 (e.g., when a consumer is away from the premises 112, etc.), view transaction history (including pending transactions, completed transactions, cancelled transactions, etc.), provide/define purchase rules defining when the commerce engine 114 should and should not initiate transactions, as indicated above, manage his/her profile (e.g., define preferences, set user credentials, etc.), manage profiles for other users of the commerce engine 114 (e.g., define preferences, set user credentials, etc.), and/or manage loyalty services.

In addition, at the management interface, in this embodiment, the consumer is able to control authentication of the consumer and/or of transactions by the commerce engine 114. In particular, for example, the commerce engine 114 may be configured to require a biometric and/or device authentication of the consumer prior to initiating a transaction (e.g., upon receiving a purchase instruction from a device based on a corresponding purchase rule being satisfied, etc.). The authentication may be provided directly to the commerce engine 114, for example, via an input to input device 208 and/or a detection of an authentication device via network interface 210 and/or input device 208, etc. In one example, the commerce engine 114 detects a device ID associated with the consumer's smartphone or vehicle (e.g., a vehicle in the driveway/garage at the premises 112, etc.), which then serves to authenticate the consumer (e.g., that the consumer is present at the premises 112, etc.) and permit the transaction to proceed. In another example, the commerce engine 114 may communicate with the consumer's communication device and request authentication in connection with a transaction (e.g., biometric voice authentication at the consumer's communication device, etc.).

Further at the management interface, the consumer may be able to control release of transactions by the commerce engine 114. For example, the commerce engine 114 may queue transactions prior to initiating the transactions (e.g., the consumer may receive notifications at his/her communication device that transactions are in the queue, etc.), whereby the consumer is able to view and release one or more of the transactions through the management interface and/or another interface associated with the commerce engine 114 (and/or associated with the consumer's communication device).

The management interface may also permit the consumer to create and store a profile in the commerce engine 114 (and/or associated memory 204), as generally described above. The profile may be specific to the consumer, or it may be specific to the premises 112. The profile may also distinguish between different types of consumers (e.g., parent-child, owner-guest, etc.), and on that basis, provide different permissions. Further, the profile may define the device ID associated with the consumer (e.g., with the consumer's smartphone or vehicle, etc.), which permits the commerce engine 114 to not only authenticate the consumer but also to identify the presence of the particular device having the device ID at the premises 112 (e.g., a smartphone (with an active companion application to the commerce engine 114) broadcasting the device ID, etc.). In this manner, by use of the device ID, the commerce engine 114 is able to distinguish between different consumers at the premises 112, prior to or after initiating a transaction. In various embodiments, the profile may also include a payment account credential associated with a payment account or other account for the consumer, whereby the commerce engine 114 may cause payment transactions to and/or from accounts, per person. Further, the profile may include various preferences of the consumer (e.g., merchant preferences, product preferences, delivery preferences, purchase notification preferences, purchase authorization preferences, authentication preferences, etc.) to be implemented by the commerce engine 114 in connection with performing purchase transactions.

In various embodiments, the commerce engine 114 is then configured to retrieve the profile(s) as needed to enable the commerce engine 114 to operate as described herein (e.g., to initiate transactions, etc.).

The management interface may further permit the consumer to disable, or enable, all connected devices 116, or select ones of the devices, as desired (e.g., via a activation switch, a kill switch, etc.).

In other embodiments, the system 100 may not include particular management interfaces for the consumer to define purchase rules, or otherwise interact with the system 100. Instead, in these embodiments, particular ones of the devices 116 may include interfaces that, upon initiation of a purchase transaction, facilitate communication of purchase information, by the devices 116, to the commerce engine 114, using a defined command set whereby the purchase information includes, for example, a quantity, a feature set (e.g., filter model A, etc.), or other information. And, in still other embodiments, the consumer may be permitted to communicate with (e.g., provide purchase rules to, etc.) the commerce engine 114, apart from any management interface. For example, the consumer, via a communication device (not shown), may direct an email, SMS, message, command, or other instruction to the commerce engine 114 (but not through a management interface specific to the commerce engine 114), which receives the instruction, and acts accordingly (e.g., stores new purchase rules, identifies new devices in the system 100, etc.). In still further embodiments, the consumer may be permitted to communicate with (e.g., provide commands to, etc.) the commerce engine 114, apart from any management interface, via one or more of the devices 116 coupled to (or in communication with) the commerce engine 114. For example, the consumer, via a communication device (not shown), may direct an email, SMS, message, command, or other instruction to one or more of the devices 116, which receives the instruction, and acts accordingly (e.g., initiates a purchase transaction, communicates with the commerce engine 114 as necessary, etc.).

In various embodiments of the system 100, one or more of the devices 116 (or one or more other similar devices) may include a contactless panel to facilitate payments to on-site service providers, for example, associated with the devices, etc. Or, such a contactless panel may be disposed at the premises 112, in communication with the commerce engine 114, for operation as described herein. For example, upon arrival at the premises 112, a landscaper may tap a payment card or a device enabled to transmit payment cards via NFC (e.g., a communication device enabled with a virtual wallet application, etc.) at such a contactless panel at the premises 112 to indicate that work has started. Upon completion of the work, the landscaper may then again tap on the contactless panel using the same payment card or device enabled to transmit payment cards via NFC. Subject to previously determined rules (e.g., only enable push payments between certain hours when work is expected, only enable push payment to certain accounts once a month, etc.), the commerce engine 114 may in turn initiate a push payment using, for example, MasterCard Send, etc., to the payment account associated with the card or device tapped by the landscaper.

In various embodiments of the system 100, one or more of the devices 116 (or one or more other similar devices) may also (or alternatively) include a contactless terminal to facilitate payment acceptance in lieu of an e-wallet application. Or, such a contactless terminal may be disposed at the premises 112, in communication with the commerce engine 114, for operation as described herein. For example, in the case of home sharing where multiple individuals share the premises 112 (e.g., renters, guests, patrons, etc.), use of certain devices 116 may require the individuals to actively tap a card (or an enabled device with payment credentials associated therewith) at the contactless terminal to enable the device 116 and/or the commerce engine 114 to transmit payment card credentials, for the individual, at the time of use/purchase at the given device 116.

In various embodiments of the system 100, other digital financial services may be paired with the commerce engine 114. For example, budgeting or loyalty services may be provided (e.g., by the payment network 106, by the issuer 108, by a third-party provider, etc.) to the consumer associated with the premises 112 (or to another individual initiating payment account transactions at the premises 112) to monitor, control, or otherwise influence spend initiated by the commerce engine 114.

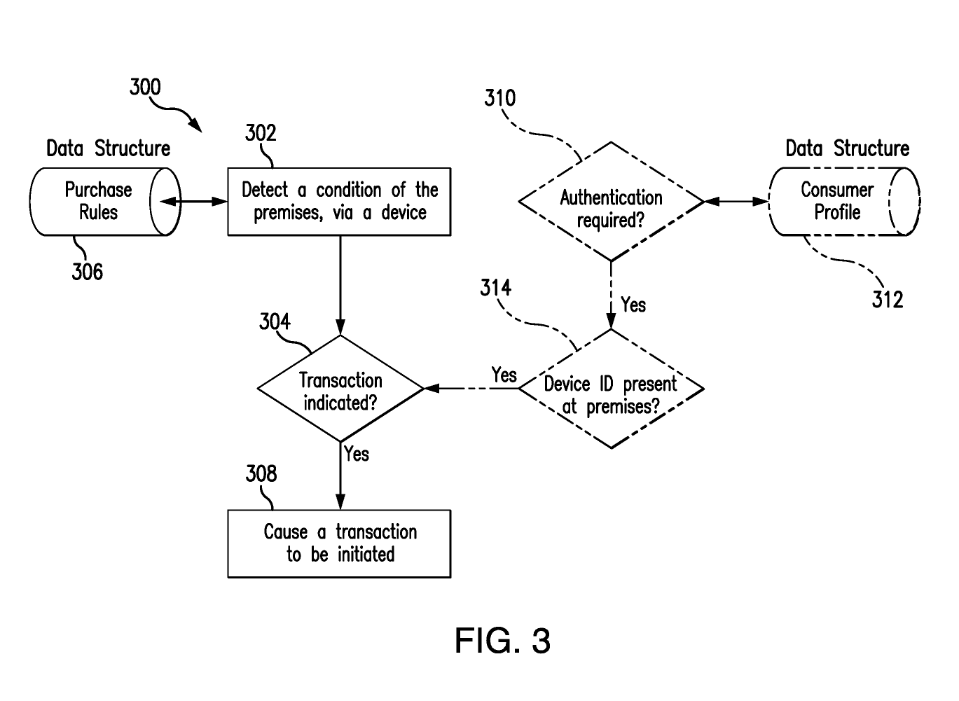

FIG. 3 illustrates an exemplary method 300 for coordinating commerce associated with a premises. For purposes of illustration, method 300 is described with reference to system 100, and in particular, to the commerce engine 114 and to computing device 200. It should be understood, however, that method 300 is not limited to the systems and methods herein and, similarly, the systems and computing devices herein are not limited to the method 300.

At 302 in the method 300, a condition of the premises 112 is detected via at least one of the devices 116. For example, the device 116 may indicate a low level, a number of cycles, a chemical concentration, usage, and/or other condition, via an input from the device 116. And, in connection therewith, the device 116 may determine if the condition satisfies one or more corresponding rules. Often, the device 116 will access a data structure 306 (e.g., in memory 204 of the device 116, in memory associated with the commerce engine 114, etc.) to determine if a transaction is indicated, where the data structure 306 includes one or more purchase rules, as described above, against which the detected condition can be compared to determine if the transaction is indicated. When the one or more corresponding rules are satisfied, the device 116 transmits an instruction to the commerce engine 114 regarding the condition (e.g., a purchase instruction, etc.). While in the method 300, the device 116 applies the one or more corresponding rules to the condition, it should be appreciated that in other embodiments the commerce engine 114 may retrieve the condition from the device 116 and/or receive the condition from the device 116 (such that the commerce engine 114 then, broadly, detects the condition) and then apply appropriate rules thereto (e.g., as retrieved from the data structure 306, etc.). Regardless, once the condition is detected and the appropriate rules are applied thereto, the commerce engine 114 determines if a transaction is indicated thereby, at 304 (e.g., the commerce engine 114 determines if the communication from the device 116, as associated with the condition, includes a purchase instruction from the device 116; etc.).

When the commerce engine 114 determines a transaction is to be initiated (e.g., when a detected condition for one of the devices 116 satisfies a corresponding purchase rule, when one of the devices 116 transmits a purchase instruction to the commerce engine 114, etc.), the commerce engine 114 causes, at 308, a transaction to be initiated consistent therewith. In particular, for example, the commerce engine 114 transmits a payment credential (broadly, a purchase request), including its token, to a merchant indicated in the purchase rule giving rise to the transaction (e.g., merchant 102, etc.) (or to a merchant otherwise identified by the device 116 and/or the commerce engine 114). In some embodiments, the commerce engine 114 may notify the consumer of the transaction and/or request approval of the transaction from the consumer, prior to causing the transaction. Such action may be provided in the profile for the consumer (e.g., requiring the commerce engine 114 to notify and/or solicit approval from the consumer for each transaction or for particular transactions, etc.), or such action may be included as part of a purchase rule implicated by a particular condition detected by the given device 116. In any case, when such approval is required by the consumer, the commerce engine 114 then causes the transaction to be initiated upon receiving the approval from the consumer.

As shown in FIG. 3, prior to determining if a transaction is indicated, the commerce engine 114, optionally (as indicated by the dotted lines), may determine if authentication is required, at 310. To do so, the commerce engine 114 accesses a data structure 312 (e.g., in memory 204 of the commerce engine 114, etc.) including consumer profiles. The commerce engine 114 then pulls the device identifier (ID) for the consumer (e.g., for the consumer's smartphone or vehicle, etc.) from the consumer profile and determines, at 314, whether the consumer is at the premises 112 (i.e., consistent with the consumer profile). If so, the commerce engine 114 is permitted to proceed to determine if a transaction is indicated, at 304.

Further, prior to causing a transaction to be initiated (at 308), the commerce engine 114 may confirm the purchase transaction based on at least one rule (e.g., based on at least one confirmation rule, etc.). In so doing, the commerce engine 114 employs the at least one rule to inhibit superfluous, unnecessary or unwanted purchases of products by the devices 116, merely based on conditions of the devices 116 (e.g., with the understanding that the conditions may sometimes erroneously indicate that products should be purchased, etc.). For example, a condition at a washing machine device 116 may indicate repeated purchases of a product, such as repeated purchases of laundry detergent every other day for the last week. But the commerce engine 114 may apply a rule indicating that the consumer associated with the premises is to be notified if the washing machine device 116 submits more than one purchase instruction within a week. In so doing, by attempting to confirm the purchase instruction from the device 116, the commerce engine 114 recognizes (based on the at least one rule) the repeated purchase transactions and withholds confirmation of the purchase transaction until verification from the consumer is received. In this manner, the commerce engine 114, while accepting purchase instructions from the individual devices 116, generally provides a supervisory control of the purchase transactions requested by the devices 116 (e.g., via the additional confirmation rules, etc.). Various additional example rules associated with such confirmation by the commerce engine 114 may include, without limitation, requiring verification from the consumer associated with the premises 112 for all transactions over a predefined amount (based on purchase instructions from all devices 116, or based on purchase instructions from particular ones of the devices, etc.); requiring verification from the consumer for a transaction based on a purchase instruction from a device 116, where the device 116 has requested more than a predefined number of transactions (e.g., two, three, five, ten, other numbers, etc.) (via multiple purchase instructions) in a given time frame (e.g., one week, one month, etc.); allowing transactions to predefined merchants and/or for predefined products (and rejecting others); allowing payment for given transactions to a specified payment account (e.g., associated with the consumer, associated with another user, etc.) for particular ones of the devices 116, during predefined time periods, and/or when the given transactions are for predefined amounts (or ranges of amounts); requiring verification from the consumer when total payments for transactions in a given period (e.g., one week, one month, a statement cycle, etc.) exceed a predefined amount; requiring verification from the consumer for all transactions initiated by a registered user at the premises (e.g., in connection with the various aspects below, etc.); etc.

In addition to the above, the commerce engine 114 may be configured to manage and/or participate in one or more other aspects of the present disclosure, which may further provide conditions relating to potential initiation of transactions by the commerce engine 114, direct bases for the commerce engine 114 to initiate (or not) transactions, and/or provide further operations in addition to those related to initiation of transactions.

In one aspect of the present disclosure, the commerce engine 114 may be configured to connect and/or interact with commerce engines implemented at premises adjacent to and/or in a same neighborhood as the premises 112 (but disassociated with the premises 112).

For example, a neighborhood may include five different premises (including the premises 112), each having a residential home with a salt water swimming pool. Each of the commerce engines (including commerce engine 114) may be configured to monitor run times of the pool pump for the respective swimming pool, chemical concentration in the water of the swimming pool, and/or scheduled chemical additions to the water, etc. (with each of the commerce engines being associated with a different one of the premises, and disassociated with the other ones of the premises). On this basis, each of the commerce engines (including commerce engine 114) may be configured to determine when additional chemicals should be ordered for the premises associated therewith (based on input from corresponding devices associated with the pools at the premises). Upon determination by the commerce engine 114 that a purchase of pool chemicals is needed at the premises 112, for example, or imminent, the commerce engine 114 may communicate with the other commerce engines in the neighborhood (e.g., via network 110, via a home commerce engine cloud, etc.) to determine if other premises need chemicals, or are close to making a chemical purchase. If so, the commerce engine 114 may coordinate with the other commerce engines to cause a bulk purchase transaction for pool chemicals, for all premises in need. In particular, upon receiving the communication from the commerce engine 114, a home commerce engine network cloud may apply additional purchase rules to the identified condition (based on the different commerce engines associated with the cloud) and communicate revised purchase instructions to the commerce engine 114. In turn, the commerce engine 114 may then cause the pool chemicals to be purchased and delivered to the premises 112, and provide a message to the consumer with instructions on distribution. The purchase transaction may be made to the payment account associated with the consumer at the premises 112, and later rectified with the other consumers at the other premises in the neighborhood through the commerce engine 114. Or, the purchase transaction may be made to a group account associated with all of the consumers in the neighborhood implicated by the transaction. Regardless, in this manner, the neighborhood (or other groups of commerce engines) may find savings in reduced shipping fees, bulk purchasing, etc. In one or more embodiments, a shipping entity may provide incentives to the consumers in the neighborhood to encourage bulk ordering and shipping.

It should be appreciated that, while pool chemicals are provided in the above example, any product, used at multiple premises, may be the subject of a bulk order (or transaction) through interactions among multiple commerce engines, for example, in neighboring and/or adjacent premises, etc. In addition, while the commerce engines are associated with neighboring and/or adjacent premises in the above example, it should be appreciated that commerce engines at premises otherwise related may similarly interact (e.g., commerce engines associated with multiple premises owned by the same consumer, etc.).

In another aspect of the present disclosure, the commerce engine 114 may include at least one input device (e.g., input device 208, etc.) and/or network interface (e.g., network interface 210, etc.) suitable to interact with service providers at the premises 112 (or other guests or visitors or participants at the premises 112) (e.g., a contactless panel, a contactless terminal, etc. as described above in connection with the system 100), whereby the service providers (or others) are able to notify the commerce engine 114 of their presence and the performance of service. In general, each of the service providers (e.g., each worker, employee, etc. thereof) is associated with a profile at the commerce engine 114, which may include one or more device ID for each of the service providers and account information, so that the commerce engine 114 may cause push payments (from the payment account associated with the commerce engine 114) to the service providers, as appropriate (e.g., in a similar manner to that described above in the system in connection with the contactless panel, contactless terminal, etc. features; etc.). The profiles may be pre-established by the consumer via the management interface.

For example (and similar to the landscaping example described above), when a landscaping service arrives to cut the grass at the premises 112 or provide other services, a worker may interact with the commerce engine 114, thereby informing the commerce engine 114 of his/her presence at the premises 112. The interaction may be manual, where the worker enters a code at the commerce engine 114 (via an input device) or otherwise provides an input to the commerce engine 114, or it may be automatic, where the commerce engine 114 detects a device (e.g., a smartphone, a vehicle, etc.) associated with the worker and/or landscaping service, or it may be via a contactless panel or terminal. The particular device may initially be identified to the commerce engine 114 through the management interface, by the consumer associated with the premises 112, so that it can subsequently be identified. As such, if the worker is paid $35 each time he/she cuts the grass at the premises 112, when the commerce engine 114 detects the worker's device, initially or for a period of time, the commerce engine 114 may push a $35 payment to an account indicated in the worker's profile.

As another example, a household employee (e.g., a nanny, a cleaning person, etc.) may interact with the commerce engine 114 as a time clock for arrival and departure from the premises 112. Again, the interaction may be manual or it may be automatic, for example, based on the commerce engine's detection of a device associated with the household employee, etc. The commerce engine 114 may then provide one or more reports to the consumer of the premises 112 regarding attendance/presence of the household employee and/or cause a payment to an account of the employee (as indicated in the employee's profile) from the payment account associated with the commerce engine 114.

As still a further example, a household employee (e.g., a nanny, a cleaning person, etc.) may again interact with the commerce engine 114 as a time clock for arrival and departure from the premises 112. And, again, the interaction may be manual or it may be automatic, for example, based on the commerce engine's detection of a device associated with the household employee, etc. The commerce engine 114 may then provide one or more reports to the consumer of the premises 112 regarding attendance/presence of the household employee. In this example, the commerce engine 114 may then cause a payment to an account of the employee (as indicated in the employee's profile) from the payment account associated with the commerce engine 114, at a later time, following confirmation of the report by the consumer/homeowner.

In yet another aspect of the present disclosure, the commerce engine 114 may include multiple profiles for different consumers present (or potentially present) at the premises 112. The different profiles may permit the commerce engine 114 to perform differently, per profile, for each of the different consumers, for example, based on preference, status, authority, etc.

For example, the consumers present at the premises 112 may include a parent and a child. A parent profile for the parent may allow the commerce engine 114 to initiate any kind of purchase transaction regarding the premises 112, while a child profile for the child may limit the commerce engine 114 to initiating only certain purchase transactions. As such, when the commerce engine 114 determines that a purchase transaction is to be made (or is requested to be made), the commerce engine 114 attempts to detect the particular consumer associated with the purchase transaction to determine if sufficient authority exists for the transaction. In so doing, the commerce engine 114 may identify the consumer by detecting a device associated with the consumer such as, for example, a smartphone, a vehicle, etc. Or, such detection may be based on the particular consumer accessing/connecting with (e.g., logging in to, etc.) the commerce engine 114. In turn, in connection with facilitating a transaction in connection with a device 116 at the premises 112, the commerce engine 114 is configured to pair with a digital wallet service at the payment network 106 (e.g., Masterpass by MasterCard®, etc.) and with a tokenization service (e.g., the MDES service by MasterCard®, etc.) to acquire and store tokenized credentials associated with the particular consumer's payment account.

As another example, the premises 112 may include a bed and breakfast, and the consumers present at the premises 112 may include an owner/operator of the premises 112 and multiple guests. As such, the owner/operation may be associated with one profile and the guests may be associated with different profiles. In this manner, purchase control, via the commerce engine 114, may be unlimited for the owner/operator, but limited in various degrees for the guests. Further, the profile for each guest (or some guest) may include a device ID for his/her smartphone (or other device), such that commerce engine 114, by detecting the device, may be able to associate certain services (and related transactions) with the particular guest, such as, for example, transactions for movies, bike rentals, etc.

In another aspect of the present disclosure, the commerce engine 114 may be able to manage and deploy loyalty rewards and/or incentives to particular people at the premises 112 for performing various actions at the premises 112 (e.g., as described above in connection with the system 100, etc.).

For example, the premises 112 may include a household with two parents and a child. Via the management interface, the parents may initially create rules for the child (stored in memory 204 of the commerce engine 114, for example) that reward the child for performing certain chores at the household. In particular, when the child takes out garbage, the child (or one of the parents) may interact with the commerce engine 114 (e.g., manually, automatically (by detecting movement of trashcans, etc.), etc.), thereby informing the commerce engine 114 that the child has performed a chore. After a particular amount of rewards are earned by the child, the commerce engine 114 may interact with other devices 116 in the household to permit access, for example, to an application at a particular tablet device associated with the child or to a different media device for a particular time period. In another example, after a particular amount of rewards, the commerce engine 114 unlocks or otherwise permits a transaction associated with the child and/or the premises 112 to be initiated.

In still another aspect of the present disclosure, the commerce engine 114 may facilitate pay-per-use devices at the premises 112. For example, a device may be “purchased” under pay-per-use terms, where the commerce engine 114 is configured to detect use of the device and then initiate a transaction for payment of the per-use amount (e.g., a payment of $5 for a washing machine per load of laundry, etc.). The pay-per-use terms may be continued, by the commerce engine 114, until a certain payment amount is achieved (i.e., until the device is paid for). It should be appreciated that any number of devices may be purchased under per-use payment terms and registered to the commerce engine 114 (via a management interface, for example), whereby the commerce engine 114 coordinates payment for the device.

In view of the above, the systems and methods herein provide commerce associated with a premises, wherein a commerce engine is associated with at least one payment credential and transactions may be coordinated in an efficient and/or convenient manner. The consumer associated with the premises may further provide payment credentials to the commerce engine and set up purchase rules to define his/her participation (e.g., authentication, release, etc.), if any, in the transactions. The systems and methods herein further provide a variety of interactions with devices at the premises, devices associated with consumers, and other commerce engines, whereby commerce associated with the premises is coordinated.

It should be appreciated that the functions described herein, in some embodiments, may be described in computer executable instructions stored on a computer readable media, and executable by one or more processors. The computer readable media is a non-transitory computer readable media. By way of example, and not limitation, such computer-readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations and/or configurations recited in any of the system or method claims below.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements/features recited in the claims are intended to be a means-plus-function element within the meaning of 35 U.S.C. §112(f) unless an element is expressly recited using the phrase “means for,” or in the case of a method claim using the phrases “operation for” or “step for.”

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for coordinating commerce associated with a premises, the method comprising:
detecting a condition of a premises via a device at the premises;
determining whether a product purchase is indicated based on the detected condition; and
when a product purchase is indicated, initiating, by a commerce engine at the premises, a purchase transaction for a product associated with the product purchase determination, using a payment credential associated with a payment account and included in the commerce engine.

2. The computer-implemented method of claim 1, wherein determining whether a product purchase is indicated is based on at least one purchase rule; and
wherein the at least one purchase rule identifies a particular merchant for the purchase transaction.

3. The computer-implemented method of claim 2, further comprising applying, by the device at the premises, the at least one purchase rule to determine whether a product purchase is indicated based on the detected condition.

4. The computer-implemented method of claim 1, wherein determining whether a product purchase is indicated includes receiving, by the commerce engine, a purchase instruction for the product from the device;
further comprising confirming, by the commerce engine, the purchase transaction for the product based on at least one rule prior to initiating the purchase transaction for the product.

5. The computer-implemented method of claim 1, further comprising accessing, by the commerce engine, a profile from a data structure; and
wherein initiating the purchase transaction includes initiating the purchase transaction consistent with the profile.

6. The computer-implemented method of claim 5, wherein the profile includes a device ID; and
wherein initiating the transaction consistent with the profile includes determining that a communication device having the device ID is present at the premises.

7. The computer-implemented method of claim 1, wherein the commerce engine is connected to multiple different permitted devices at the premises, including the device.

8. The computer-implemented method of claim 1, wherein the payment credential includes a token associated with the payment account; and
wherein initiating the purchase transaction includes transmitting a purchase request, including the token, to a merchant.

9. A system for coordinating commerce associated with a premises, the system comprising:
a commerce engine for coupling to multiple permitted devices at a premises, each of the multiple devices providing data associated with the premises;
wherein the commerce engine is linked to a payment token associated with a payment account; and
wherein the commerce engine is configured to:
receive a purchase instruction for a product from at least one of the multiple devices based on a condition of the at least one of the multiple devices, the product associated with the at least one of the multiple devices;
confirm the purchase instruction based on at least one rule; and
when the purchase instruction for the product is confirmed, cause a purchase transaction for the product to be initiated, using the payment token, with a merchant.

10. The system of claim 9, wherein the product and the merchant are defined by the purchase instruction.

11. The system of claim 9, wherein the commerce engine is further configured to coordinate with at least one other commerce engine disassociated with the premises, prior to causing the purchase transaction, whereby the commerce engine determines if the at least one other commerce engine is able to participate in a bulk transaction including the purchase transaction.

12. The system of claim 9, further comprising the at least one device;
wherein the at least one device is configured to:
determine whether the purchase of the product is indicated based on the detected condition and based on at least one purchase rule, the at least one purchase rule including:
an indication of the product for purchase; and
at least one parameter; and
provide the purchase instruction to the commerce engine when the at least one parameter is satisfied by the detected condition of the at least one of the multiple devices.

13. The system of claim 9, wherein the commerce engine is further configured to detect a presence of a person at the premises, based on a device ID for a communication device associated with the person; and
wherein the commerce engine is configured to cause the purchase transaction when indicated and only when the person is detected at the premises, but halt the purchase transaction when the person is not detected at the premises.

14. The system of claim 9, wherein the commerce engine is further configured to detect a presence of a person at the premises, based on a device ID for a communication device associated with the person;
wherein the commerce engine is configured to cause the purchase transaction only after detecting the person at the premises; and
wherein the commerce engine is configured to associate the purchase transaction with the person.

15. A non-transitory computer readable storage media including executable instructions for coordinating commerce associated with a premises, which, when executed by at least one processor, causes the at least one processor to:
receive a purchase instruction for a product from at least one of multiple devices located at a premises based on a condition at the premises detected by the at least one of the multiple devices, the product including a product used by the at least one of the multiple devices at the premises; and
initiate a purchase transaction with a merchant for the product, based on the purchase instruction, using a payment credential for a payment account of a consumer associated with the premises.

16. The non-transitory computer readable storage media of claim 15, wherein the product and the merchant are defined by the purchase instruction.

17. The non-transitory computer readable storage media of claim 16, wherein the executable instructions, when executed by the at least one processor, further cause the at least one processor to confirm the purchase instruction based on at least one confirmation rule; and
wherein the executable instructions, when executed by the at least one processor, cause the at least one processor, in connection with initiating the purchase transaction, to only initiate the purchase transaction when the at least one confirmation rule is satisfied.

18. The non-transitory computer readable storage media of claim 15, wherein the payment credential includes a token associated with the payment account; and
wherein the executable instructions, when executed by the at least one processor, cause the at least one processor, in connection with initiating the purchase transaction, to transmit a purchase request, including the token, to a merchant.

19. The non-transitory computer readable storage media of claim 18, wherein the executable instructions, when executed by the at least one processor, further cause the at least one processor to coordinate with at least one commerce engine disassociated with the premises, prior to initiating the purchase transaction, whereby the at least one processor determines if the at least one commerce engine is able to participate in a bulk transaction including the purchase transaction.

20. The non-transitory computer readable storage media of claim 18, wherein the executable instructions, when executed by the at least one processor, further cause the at least one processor to detect a presence of a person at the premises, based on a device ID for one of a communication device associated with the person and a vehicle associated with the person; and
wherein the executable instructions, when executed by the at least one processor, cause the at least one processor, in connection with initiating the purchase transaction, to initiate the purchase transaction only when the person is detected at the premises.
